(19) United States
(12) Patent Application Publication
(10) Pub. No.: US 2007/0001817 A1
(43) Pub. Date: Jan. 4, 2007

(54) PHASE MODULATION APPARATUS, RFID TAG, READER/WRITER AND PHASE MODULATION METHOD

(75) Inventor: Hideaki YAMADA, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/428,051

(22) Filed: Jun. 30, 2006

(30) Foreign Application Priority Data
Jun. 30, 2005 (JP) 2005-191525

(51) Int. Cl. H04Q 5/22

(52) U.S. Cl. 340/10.34; 340/10.3; 375/279

(57) ABSTRACT

A phase modulation apparatus includes a pattern-generating part that generates a phase-modulated pattern of a carrier wave, the carrier wave being phase-modulated by send data, and a phase-transition controlling part that transitions the phase of the pattern generated in the pattern-generating part, the phase being transitioned in such a way that a piece of send data is allocated to a portion of wave consisting of two or more cycles of the carrier wave.

This application claims the benefit of Japanese Patent Application No. 2005-191525, filed Jun. 30, 2005. The entire disclosure of the prior application is hereby incorporated by reference herein its entirety.

### BACKGROUND

1. Technical Field

The present invention relates to a phase modulation apparatus, a Radio Frequency Identification (RFID) tag, a reader/writer and a phase modulation method. More particularly, the invention is suitable for application to the Phase Shift Keying (PSK) modulation system.

2. Related Art

In the efforts to realize a ubiquitous society, attention is being given to the RFID system. The RFID system is constituted of RFID tags to manage individual IDs and data of things as well as persons and reader/writers for identifying and controlling the IDs. An RFID tag is capable of operating without any internal battery because it generates power through electromagnetic induction caused by receiving electric waves and magnetic fields outputted from the antenna of a reader/writer.

On the other hand, the nonpatent literature “Ubiquitous Radio Engineering and Micro RFID,” for example, written by Hideyuki Nebiya and Kotomi Uetake and published by Tokyo Denki Universitv Press, discloses the BPSK modulation system as a modulation system for sending digital data over the air, in which “1” and “0” are respectively allocated to “0°” and “180°” of the phase of a carrier wave.

However, in a common phase modulation method, the phase is changed (“0°”<=>“180°”) in one carrier wave in response to changing data (“1”<=>“0”). Thus, a problem has existed in the method in that the 1.5×n content and the harmonic content of the carrier wave emerge by large amounts to increase the leak electrical field (out-of-band transmission spectrum), thereby occasionally causing infringements of the provisions of the Radio Law.

### SUMMARY

An advantage of some aspects of the invention is to provide a phase modulation apparatus, an RFID tag, a reader/writer and a phase modulation method that are capable of suppressing the leak electrical field occurring at the time of a phase modulation of digital data.

According to a first aspect of the invention, a phase modulation apparatus includes a pattern-generating part that generates a phase-modulated pattern of a carrier wave, the carrier wave being phase-modulated by send data, and a phase-transition controlling part that transitions the phase of the pattern generated in the pattern-generating part, the phase being transitioned in such a way that a piece of send data is allocated to a portion of wave consisting of two or more cycles of the carrier wave.

This allows a piece of send data to be allocated to a portion of wave consisting of two or more cycles of a carrier wave, thereby improving the noise immunity of phase-modulated waves.

According to a second aspect of the invention, a phase modulation apparatus includes a pattern-generating part that generates a phase-modulated pattern of a carrier wave, the carrier wave being phase-modulated by send data, and a phase-transition controlling part that transitions the phase of the pattern generated by the pattern-generating part, the phase being transitioned in such a way that a piece of the send data is allocated to a portion of wave consisting of two or more cycles of the carrier wave and the phase content of the portion of wave allocated to the piece of send data changes.

This allows a piece of send data to be allocated to a portion of wave consisting of two or more cycles of a carrier wave while also allowing the phase content of a phase-modulated wave to change gradually. Hence, the harmonic content of the carrier wave can be reduced, thereby allowing the leak electrical field occurring at the time of a phase modulation to be reduced.

According to a third aspect of the invention, an RFID tag includes an antenna that receives a phase-modulated wave in which a piece of send data is allocated to a portion of wave consisting of two or more cycles of a carrier wave, a demodulation circuit that reproduces the send data, being superposed on the carrier wave, by demodulating the phase-modulated wave received by the antenna, and a power recovery circuit that partly rectifies the phase-modulated wave received by the antenna and recovers power.

This allows the noise immunity of a phase-modulated wave to be improved while allowing power generation and data reception to be carried out simultaneously on an RFID tag.

According to a fourth aspect of the invention, an RFID tag includes an antenna that receives a phase-modulated wave, in which a piece of send data is allocated to a portion of wave consisting of two or more cycles of a carrier wave and the phase content of the portion of wave allocated to the piece of send data changes, a demodulation circuit that reproduces the send data, being superposed on the carrier wave, by demodulating the phase-modulated wave received by the antenna and a power recovery circuit that partly rectifies the phase-modulated wave received by the antenna and recovers power.

This allows the leak electrical field occurring at the time of a phase modulation to be suppressed while allowing power generation and data reception on an RFID tag to be carried out simultaneously.

According to a fifth aspect of the invention, a reader/writer includes a pattern-generating part that generates, in digital data, a phase-modulated pattern of a carrier wave, the carrier wave being phase-modulated by send data, a phase-transition controlling part that transitions the phase of the pattern generated in the pattern-generating part, the phase being transitioned in such a way that a piece of the send data is allocated to a portion of wave consisting of two or more cycles of the carrier wave, a digital/analog converter that converts the pattern generated in the pattern-generating part into analog data, a current amplifier circuit that amplifies the current in the analog data obtained in the digital/analog converter and an antenna that emits the current-amplified analog data into space.

This allows the noise immunity of a phase-modulated wave to be improved while allowing power supply and data transmission to an RFID tag to be carried out simultaneously.

According to a sixth aspect of the invention, a reader/writer includes a pattern-generating part that generates, in digital data, a phase-modulated pattern of a carrier wave, the carrier wave being phase-modulated by send data, a phase-transition controlling part that transitions the phase of the pattern generated in the pattern-generating part, the phase being transitioned in such a way that a piece of the send data is allocated to a portion of wave consisting of two or more cycles of the carrier wave and the phase content of the portion of wave allocated to the piece of send data changes, a digital/analog converter that converts the pattern generated in the pattern-generating part into analog data, a current amplifier circuit that amplifies the current in the analog data obtained in the digital/analog converter and an antenna that emits the current-amplified analog data into space.

This allows the leak electrical field occurring at the time of a phase modulation to be suppressed while allowing power supply and data transmission to an RFID tag to be carried out simultaneously.

According to a seventh aspect of the invention, a phase modulation method includes allocating a piece of send data to a portion of wave consisting of two or more cycles of a carrier wave while phase-modulating the carrier wave by the send data.

This allows a piece of send data to be allocated to a portion of wave consisting of two or more cycles of a carrier wave, thereby allowing the noise immunity of a phase-modulated wave to be improved.

According to an eighth aspect of the invention, a phase modulation method includes allocating a piece of send data to a portion of wave that consists of two or more cycles of a carrier wave and changing the phase content of the portion of wave allocated to the piece of send data, while phase-modulating the carrier wave by the send data.

This allows the phase content of a phase-modulated wave to change gradually thereby allowing the leak electrical field occurring at the time of a phase modulation to be suppressed.

### BRIEF DESCRIPTION OF THE DRAWINGS

The invention will be described with reference to the accompanying drawings, wherein like numbers reference like elements.

FIG. 1 is a block diagram schematically showing the configuration of a phase modulation apparatus according to a first embodiment of the invention.

FIGS. 2A and 2B are diagrams showing an example of a phase modulation method according to a second embodiment of the invention.

FIGS. 3A and 3B are diagrams showing other examples of the phase modulation method according to a third embodiment of the invention.

FIG. 4 is a diagram showing a phase transition method in the phase modulation method of FIGS. 3A and 3B.

FIGS. 5A, 5B, 5C, 5D and 5E are diagrams showing the relation between the phase transition method according to a fourth embodiment of the invention and the leak electrical field.

FIG. 6 is a block diagram schematically showing the configuration of an RFID tag according to a fifth embodiment of the invention.

### DESCRIPTION OF EXEMPLARY EMBODIMENTS

An RFID tag and a reader/writer using a phase modulation method according to embodiments of the invention will now be described with reference to the accompanying drawings.

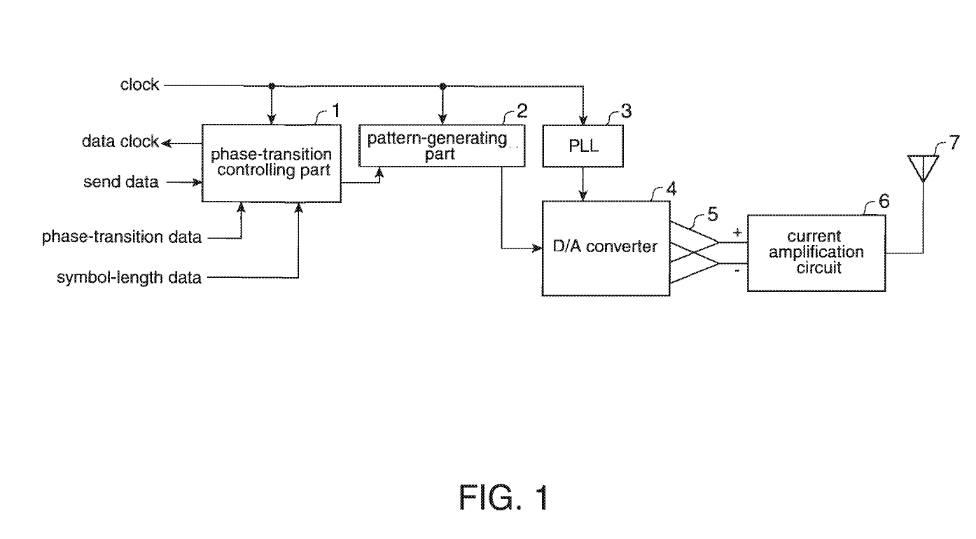

FIG. 1 is a block diagram schematically showing the configuration of a phase modulation apparatus according to a first embodiment of the invention.

In FIG. 1, the phase modulation apparatus includes a pattern-generating part 2 that generates, in digital data, a phase-modulated pattern of a carrier wave, the carrier wave being phase-modulated by send data, a phase-transition controlling part 1 that transitions the phase of the pattern generated by the pattern-generating part 2, a PLL circuit 3 that multiplies the frequency of a clock, a digital/analog converter 4 that converts the pattern generated in the pattern-generating part 2 into analog data, a low-pass filter 5 that removes any unnecessary high-pass content, a current amplifier circuit 6 that amplifies the current of the analog data obtained in the digital/analog converter and an antenna 7 that emits the analog data, whose current has been amplified by the current amplifier circuit 6, into space. The pattern-generating part 2 may be a programmable compound logical device such as a Complex Programmable Logic Device (CPLD).

The phase-transition controlling part 1 is capable of allocating a piece of data to a portion of wave consisting of two or more cycles of the carrier wave. It is also capable of transitioning the phase of the pattern generated by the pattern-generating part 2, in such a way that the phase content of the portion of wave allocated to the piece of data changes.

A symbol-length data and a phase-transition data are inputted into the phase-transition controlling part 1, the symbol-length data specilying the number of cycles of the carrier wave to which to allocate a piece of data and the phase-transition data specifying the number of cycles of the carrier wave with respect to which to transition the phase. It is preferable that the symbol-length data and the phase-transition data are set in such a way that the envelope of the carrier wave forms a sine wave. When a data clock requesting a send data is outputted from the phase-transition controlling part 1, the send data is inputted into the phase-transition controlling part 1.

The phage-transition controlling part 1 transitions the phase in such a way that a piece of data is allocated to the number of cycles of wave specified by the symbol-length data and that the phase content changes with respect to the number of cycles of wave specified by the phase-transition data. In doing so, the phase-transition controlling part generates a phase-modulated pattern of the carrier wave, being phase-modulated by the send data, in the pattern-generating part 2. A clock is inputted into the phase-transition controlling part 1 and the pattern-generating part 2, thereby allowing one cycle of the carrier wave to be represented by two or more pieces of digital data prescribed by the clock frequency. For example, provided that the carrier frequency is 13.56 MHz, a clock frequency of 108.48 MHz allows a portion of wave consisting of one cycle of the carrier wave to be represented by eight pieces of digital data.

After a phase-modulated pattern is generated in the pattern-generating part 2, the pattern is inputted into the digital/analog converter 4 and converted into analog data, thereby allowing a phase-modulated wave to be generated. Here, the clock supplied to the phase-transition controlling part 1 and the pattern-generating part 2 is inputted into a PLL circuit 3 so that the frequency is multiplied. The frequency-multiplied clock is inputted into the digital/analog converter 4, thereby allowing the phase-modulated pattern to be oversampled. The phase-modulated wave outputted from the digital/analog converter 4 is removed of zany unnecessary high-pass content in a low-pass filter 5. Then, the phase-modulated wave, whose current has been amplified in a current-amplifying circuit 6, is emitted into space through an antenna 7.

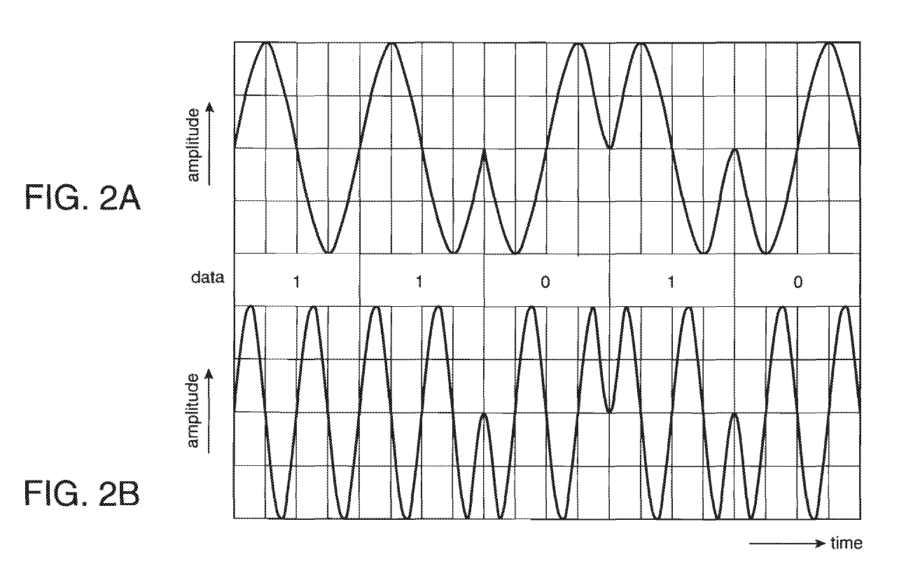

FIGS. 2A and 2B are diagrams showing an example of the phase modulation method according to a second embodiment of the invention. In the diagrams, taking the BPSK (modulation for example, “1” and “0” of send data are respectively allocated to “0°” and “180°” of the phase of a carrier wave.

In FIG. 2A, 1 bit of send data is allocated to a portion of wave consisting of 1 cycle of a carrier wave, whereas, in FIG. 2B, 1 bit of data is allocated to a portion of wave consisting of 2 cycles of a carrier wave. The noise immunity of a phase-modulated wave can be improved by allocating one piece of data to a portion of wave consisting of two or more cycles of a carrier wave.

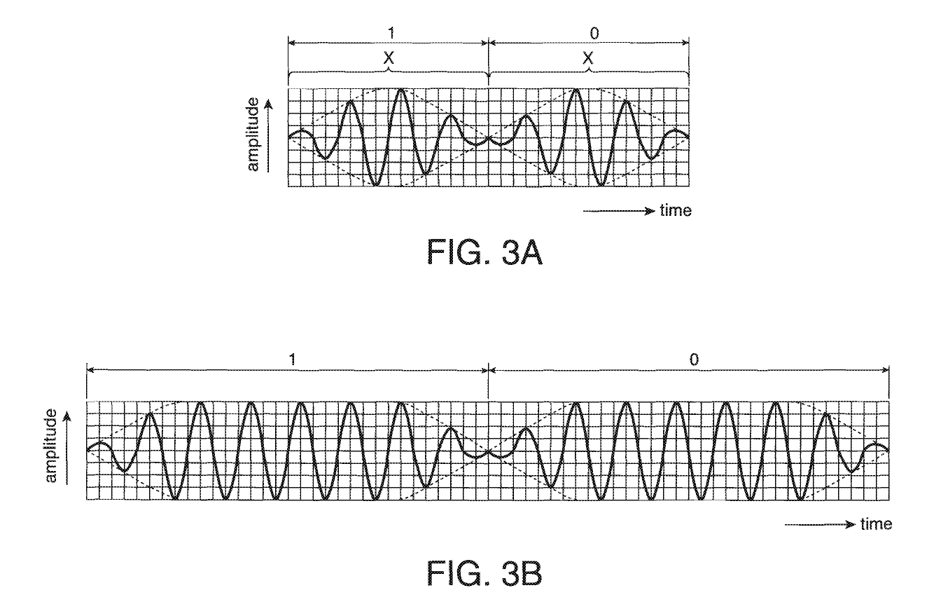

FIGS. 3A and 3B are diagrams showing other examples of the phase modulation method according to a third embodiment of the invention.

In FIG. 3A, the symbol-length data and the phase-transition data that are inputted into the phase-transition controlling part 1 shown in FIG. 1, are respectively 4 and 2. In this case, “1,” or “0°,” of the send data can be represented by a portion of wave consisting of 4 cycles. When “1” of the send data is superposed on the carrier wave, the phase content “0°” can be gradually increased from 0% to 100% for 2 cycles of the wave before it is gradually decreased from 100% to 0% for the remaining 2 cycles. On the other hand, when “0” of the send data is superposed on the carrier wave, the phase content “180°” can be gradually increased from 0% to 100% for 2 cycles of wave before it is gradually decreased from 100% to 0% for the remaining 2 cycles.

In FIG. 3B, the symbol-length data and the phase-transition data that are inputted into the phase-transition controlling part 1 in FIG. 1, are respectively 8 and 2. In this case, “1,” or “0°,” can be represented by a portion of wave consisting of 8 cycles. When “1” of the send data is superposed on the carrier wave, the phase content “0°” can be gradually increased from 0% to 100% for 2 cycles of the wave to be maintained at 100% for the following 4 cycles, before it is gradually decreased from 100% to 0% for the remaining 2 cycles. On the other hand, when “0” is superposed on the carrier wave, the phase content “180°” can be gradually increased from 0% to 100% for 2 cycles of the wave and maintained at 100% for the following 4 cycles, before it is gradually decreased from 100% to 0% for the remaining 2 cycles.

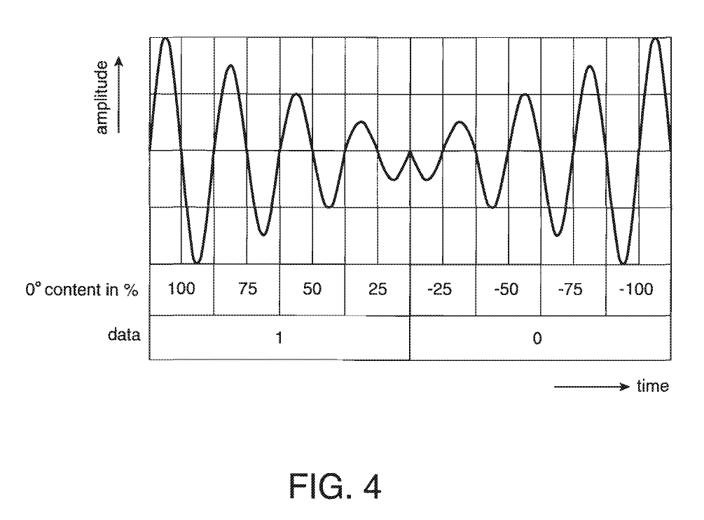

FIG. 4 is a diagram showing a phase transition method in the phase modulation method of FIGS. 3A and 3B.

In FIG. 4, it is supposed that “1” of the send data is allocated to “0°” while “0” of the send data is allocated to “180°” of the phase of the carrier wave. In this case, when “1” of the send data is superposed on the carrier wave, for example, the phase content “0°” can be gradually decreased from 100% to 0% for 2² cycles of the wave. That is, in a first cycle of the wave the phase content “0” can be 100%, whereas in a second cycle of the wave it can be 75%, in a third cycle of the wave 50% and in a fourth cycle of the wave 25%. On the other hand, for example, when “0” of the send data is superposed on the carrier wave, the phase content “180°” can be gradually increased from 0% to 100% for 2² cycles of the wave. That is, in a first cycle of the wave the phase content “180°” can be 25% (the phase content “0°” being −25%), whereas in a second cycle of the wave it can be 50% (the phase content “0°” being −50%), in a third cycle of the wave 75% (the phase content “0°” being −75%) and in a fourth cycle of the wave 100% (the phase content “0°” being −100%).

This allows a piece of send data to be allocated to a portion of wave consisting of two or more cycles of a carrier wave while also allowing the phase content of a phase-modulated wave to change gradually. Hence, the harmonic content of the carrier wave can be reduced, thereby allowing the leak electrical field occurring at the time of a phase modulation to be suppressed.

It is preferable that the symbol-length data is 2⁴ or more, considering the supply of power perform ed by a carrier wave. Furthermore, a transfer rate that is about 17 times larger (847.5 KBPS) than the rate at the time of an Amplitude Shift Keying (ASK) modulation can be obtained if a piece of send data is allocated to a portion of wave consisting of 2² cycles.

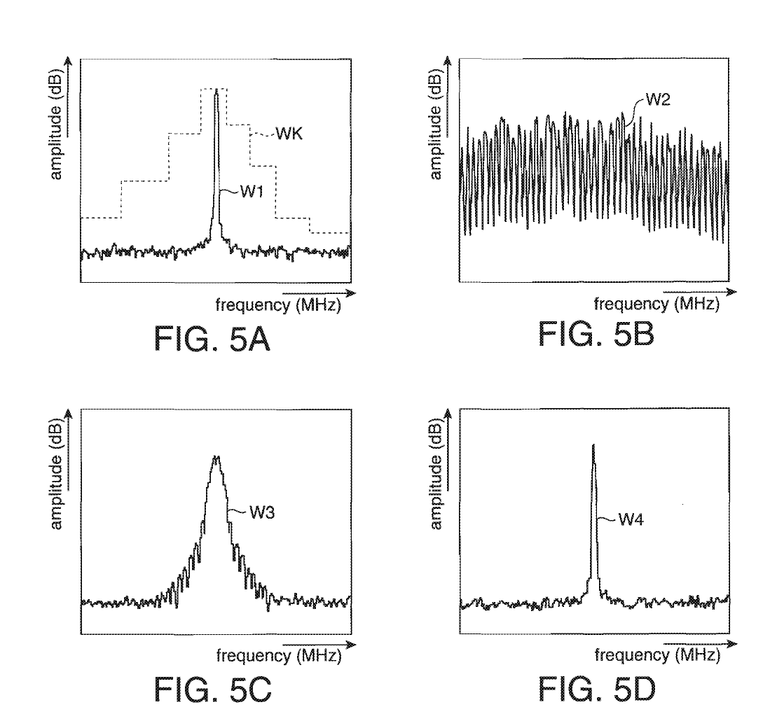

FIGS. 5A, 5B, 5C and 5D show the relation between a phase transition method according to a fourth embodiment of the invention and the leak electrical field. FIG. 5A shows the spectrum of a carrier wave before modulation, FIG. 5B shows the spectrum of a carrier wave modulated with a symbol-length data of 1 and a phase-transition data of 1, FIG. 5C shows the spectrum of a carrier wave modulated with a symbol-length data of 16 and a phase-transition data of 8 and FIG. 5D shows the spectrum of a carrier wave modulated with a symbol-length data of 32 and a phase-transition data of 16.

In FIG. 5A, supposing a bandwidth of VK for the strength of the leak electrical field, it is observed that the spectrum of the carrier wave before modulation is within the range provided for by the Radio Law. It is also shown that the spectrum of the carrier wave, having been modulated with a symbol-length data of 1 and a phase-transition data of 1, spreads transversely and does not meet the provisions of the Radio Law. The spectral width of the carrier wave becomes narrower as the symbol-length data and the phase-transition data are increased, thereby meeting the provisions of the Radio Law.

The phase modulation apparatus shown in FIG. 1 can be used in reader/writers sending data and power to RFID tags.

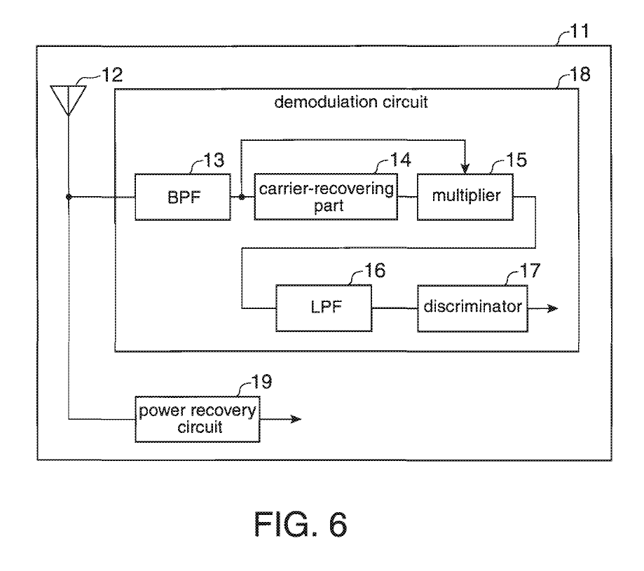

FIG. 6 is a block diagram schematically showing the configuration of an RFID tag according to a fifth embodiment of the invention.

In FIG. 6, an RFID tag 11 includes an antenna 12 that receives a phase-modulated wave generated in the phase modulation apparatus shown in FIG. 1, a demodulation circuit 18 that reproduces send data superposed on a carrier wave by demodulating the phase-modulated wave received by the antenna 12 and a power recovery circuit 19 that partly rectifies the phase-modulated wave received by the antenna 12 to recover power. Here, the demodulation circuit 18 includes a band pass filter 13, a carrier-recovering part 14, a multiplier 15, a low-pass filter 16 and a discriminator 17.

A phase-modulated wave received by the antenna 12 is sent to the band pass filter 13 to be extracted of the carrier frequency content. The phase-modulated wave, after being extracted of the carrier frequency content, is sent to the carrier-recovering part 14 to have the unmodulated carrier wave recovered, and then sent to the multiplier 15. A PLL circuit such as a Costas Loop and the frequency doubling/halving system, and the like, can be used for the carrier-recovering part 14. The phase-modulated wave outputted from the band-pass filter 13 is sent also to the multiplier 15 to be multiplied together with the unmodulated carrier wave outputted from the carrier-recovering part 14, thereby demodulating the send data. The send data demodulated in the multiplier 15 are removed of any unnecessary high-pass content in the low-pass filter 16, and then sent to the discriminator 17 to have digital data “0” or “1” reproduced.

The phase-modulated wave received bay the antenna 12 is sent to the power recovery circuit 19 to recover power for the RFID tag 11 in the circuit, thereby allowing the RFID tag 11 to operate without any battery.

What is claimed is:

1. A phase modulation apparatus, comprising:
a pattern-generating part that generates a phase-modulated pattern of a carrier wave, the carrier wave being, phase-modulated by send data; and
a phase-transition controlling part that transitions a phase of a pattern generated in the pattern-generating part, the phase being transitioned in such a way that a piece of send data is allocated to a portion of wave comprised of two or more cycles of the carrier wave.

2. A phase modulation apparatus, comprising:
a pattern-generating part that generates a phase-modulated pattern of a carrier wave, the carrier wave being phase-modulated by send data; and
a phase-transition controlling part that transitions a phase of a pattern generated in the pattern-generating part, the phase being transitioned in such a way that a piece of send data is allocated to a portion of wave comprised of two or more cycles of the carrier wave and a phase content of the portion of wave allocated to the piece of send data changes.

3. An RFID tag, comprising:
an antenna that receives a phase-modulated wave having a piece of send data that is allocated to a portion of the wave comprised of two or more cycles of a carrier wave;
a demodulation circuit that reproduces the send data superposed on the carrier wave by demodulating the phase-modulated wave received by the antenna; and
a power recovery circuit that partly rectifies the phase-modulated wave received by the antenna and recovers power.

4. An RFID tag, comprising:
an antenna that receives a phase-modulated wave having a piece of send data that is allocated to a portion of wave comprised of two or more cycles of a carrier wave and a phase content of the portion of wave allocated to the piece of send data changes;
a demodulation circuit that reproduces send data superposed on the carrier wave by demodulating the phase-modulated wave received by the antenna; and
a power recovery circuit that partly rectifies the phase-modulated wave received by the antenna and recovers power.

5. A reader/writer, comprising:
a pattern-generating part that generates, in digital data, a phase-modulated pattern of a carrier wave, the carrier wave being phase-modulated by send data;
a phase-transition controlling part that transitions a phase of the pattern generated in the pattern-generating part, the phase being transitioned in such a way that a piece of send data is allocated to a portion of the wave comprised of two or more cycles of the carrier wave;
a digital/analog converter that converts the pattern generated in the pattern-generating part into analog data;
a current amplifier circuit that amplifies a current of the analog data obtained in the digital/analog converter; and
an antenna that emits the current-amplified analog data into space.

6. A reader/writer, comprising:
a pattern-generating part that generates a phase-modulated pattern of a carrier wave, the carrier wave being phase-modulated by send data;
a phase-transition controlling part that transitions a phase of the pattern generated in the pattern-generating part, the phase being transitioned in such a way that a piece of send data is allocated to a portion of the wave comprised of two or more cycles of the carrier wave and a phase content of the portion of wave allocated to the piece of send data changes;
a digital/analog converter that converts the pattern generated in the pattern-generating part into analog data;
a current amplifier circuit that amplifies a current of the analog data obtained in the digital/analog converter; and
an antenna that emits the current-amplified analog data into space.

7. A phase modulation method, comprising:
allocating a piece of send data to a portion of the wave comprised of two or more cycles of a carrier wave, while phase-modulating the carrier wave by the send data.

8. A phase modulation method, comprising:
allocating a piece of send data to a portion of the wave comprised of two or more cycles of a carrier wave; and
changing a phase content of the portion of the wave allocated to the piece of send data, the carrier wave being phase-modulated by the send data during a period in which the allocating and the changing are carried out.
